(19) United States
(12) Patent Application Publication
(10) Pub. No.: US 2009/0002872 A1
(43) Pub. Date: Jan. 1, 2009

(54) METHOD AND APPARATUS FOR POSITIONING HEAD ON DATA TRACK WITH A VARIABLE TRACK WIDTH IN A DISK DRIVE

(75) Inventors: Katsuki Ueda, Tachikawa-shi (JP); Hideo Sado, Ome-shi (JP); Toshitaka Matsunaga, Akishima-shi (JP); Shouji Nakajima, Kodaira-shi (JP); Seiji Mizukoshi, Nishitama-gun (JP); Shinichirou Kouhara, Hino-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/146,851

(22) Filed: Jun. 26, 2008

(30) Foreign Application Priority Data
Jun. 29, 2007 (JP) 2007-173045

(51) Int. Cl. G11B 5/58

(52) U.S. Cl. 360/77.01

(57) ABSTRACT

According to one embodiment, there is provided a disk drive has a controller that performs positioning control of a head on a data track with a variable track width. The disk drive has a disk in which concentric servo tracks are configured at regular intervals and in which the positions of the individual servo tracks and servo data including position information that enables a position in the range of a servo track width to be detected in units of a specific minimum offset are recorded. The controller performs positioning control of the head on a data track with a variable track width on the basis of the servo track.

### CROSS-REFERENCE TO RELATED APPLICATIONS

This application is based upon and claims the benefit of priority from Japanese Patent Application No. 2007-173045, filed Jun. 29, 2007, the entire contents of which are incorporated herein by reference.

### BACKGROUND

1. Field

One embodiment of the present invention relates to a disk drive, and more particularly to a head positioning control technique for positioning the head in a target position on a disk.

2. Description of the Related Art

Generally, in a disk drive, such as a hard disk drive, servo data used in positioning control (servo control) of the head has been recorded on a disk serving as a magnetic recording medium. Using the servo data read by a read head included in the head, the disk drive positions the head in a target position (or on the target data track) on the disk and records user data on the disk or reproduces the user data.

In the disk drive, as the data recording density on the disk increases, the track density (tracks per inch [TPI]), that is, the number of tracks per inch, tends to increase. The head of the disk drive has a structure where a read head (or read element) and a write head (or write element) are mounted separately on the same slider. Moreover, the head, which is mounted on a rotary actuator, is moved radially relative to the disk.

As the track density on the disk increases, the following becomes increasingly likely to occur: the write head deviates to a track adjoining the target data track, depending on the positional relationship between the read head and write head separated from each other, particularly at the time of head positioning control in a data write operation, which results in interference with the user data recorded on the adjoining track.

Furthermore, the performance of a seek operation to move the head or of a data read/write operation might be impaired by disturbance caused in the disk drive, depending on the radial position of the head relative to the disk.

To overcome such a problem, measures have been proposed as follows. A method of setting track pitch data using a guard band that separates adjoining tracks has been proposed (e.g., refer to Jpn. Pat. Appln. KOKAI Publication No. 2002-237142). In addition, a method of writing data to only one of a plurality of tracks in a specified range on the disk has been proposed (e.g., refer to Jpn. Pat. Appln. KOKAI Publication No. 2006-139902).

With the proposed measures in the conventional art, the track pitch data has to be stored and therefore there is a good chance that the track density on the disk may decrease. Moreover, it is conceivable that the data track width may be made greater in a place where the aforementioned interference is liable to take place on the disk. On the other hand, from the viewpoint of securing of memory capacity, it is necessary to provide an area where the data track width is made narrower.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing a main part of a disk drive according to an embodiment of the invention;

FIG. 2 is a diagram to help explain the configuration of a server sector according to the embodiment;

FIG. 3 is a diagram to help explain the positional relationship between the head and tracks in the embodiment;

FIG. 4 is a diagram to help explain the configuration of servo tracks according to the embodiment;

FIGS. 5A and 5B are diagrams to help explain a data track whose track width is varied in the embodiment;

FIG. 6 is a partially enlarged view of FIG. 5A;

FIG. 7 is a flowchart to help explain the procedure for computing the address of a servo track in the embodiment;

FIG. 8 is a diagram showing a state of the variable track width of a data track in the embodiment;

FIG. 9 is a diagram showing an address correction value for a servo track in the embodiment;

FIG. 10 is a diagram showing a state of TPI of a data track in the embodiment;

FIG. 11 is a diagram showing a state of a variable track width of a data track in one other embodiment of the invention; and

FIG. 12 is a diagram showing an address correction value for a servo track in the one other embodiment.

### DETAILED DESCRIPTION

Various embodiments according to the invention will be described hereinafter with reference to the accompanying drawings. In general, according to one embodiment of the invention, there is provided a disk drive for realizing a head positioning operation with sufficient accuracy without decreasing the track density even when the data track width is varied.

(Disk Drive and Servo Control System)

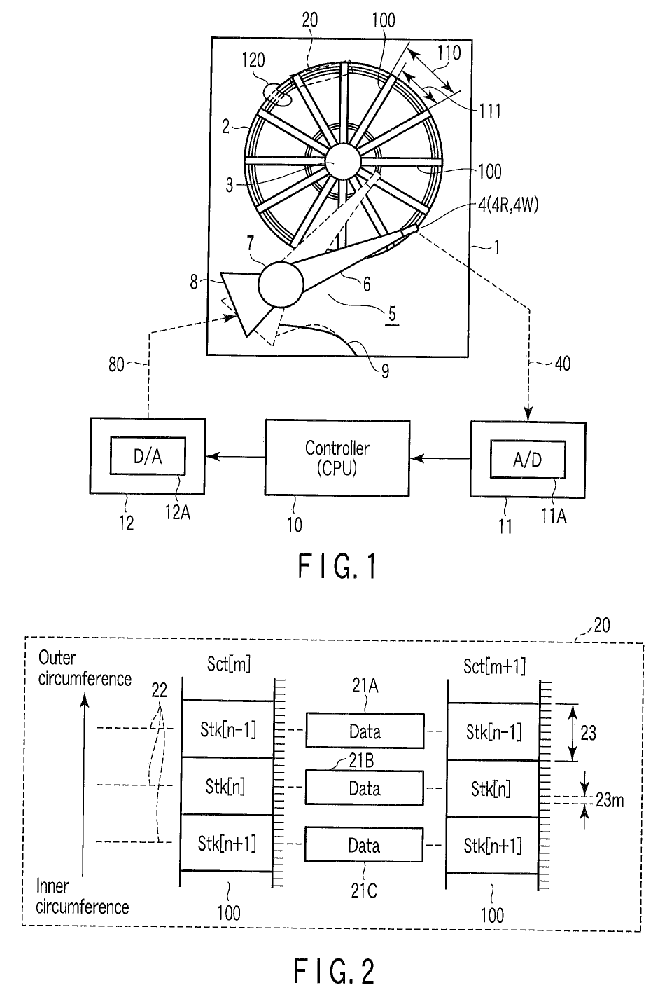

According to an embodiment, FIG. 1 shows a block diagram of a main part of a disk drive according to an embodiment of the invention.

A disk drive 1 includes a disk 2 serving as a magnetic recording medium, a spindle motor 3 which holds the disk 2 and rotates it, and a head 4 mounted on an actuator 5. The head 4 has a structure where a read head (or read element) 4R and a write head (or write element) 4W are mounted on the same slider in such a manner that they are separated from each other. The read head 4R reads servo data and user data recorded on the disk 2. The write head 4W writes user data to the disk 2.

The actuator 5, which is a rotary actuator, includes an arm 6 which holds the head at its tip, a rotation axis 7, and a voice coil motor (VCM) 8 which generates driving force. Driven by the VCM 8, the actuator 5 moves the head 4 radially relative to the disk 2.

The head 4 is connected to a head amplifier (not shown) mounted on a flexible circuit board 9. Via the head amplifier, the head 4 inputs and outputs a read/write signal. A flexible circuit board 9 is connected to a printed circuit board (PCB) on which a servo control system of the embodiment is mounted.

The servo control system includes a controller 10 composed of a microprocessor (CPU), a position detecting unit 11, and a VCM driver 12. Specifically, the position detecting unit 11, which is included in a signal processing unit called a read/write channel, reproduces servo data from a servo signal 40 read by the read head 4R. The position detecting unit 11 includes an analog-to-digital converter 11A for converting the servo signal, an analog signal, into servo data, a digital signal 40, and generates position information that indicates the radial position of the head 4.

The controller 10, which is a main controller for the disk drive 1, specifies a target track (or target position) to which data is recorded or from which it is reproduced and performs positioning control (or servo control) to position the head 4 on the target track. The controller 10 calculates a controlled variable necessary for positioning control and outputs the calculation result, a digital value, to the VCM driver 12.

The VCM driver 12, which includes a digital-to-analog converter 12A, converts the controlled variable from the controller into current 80 and supplies the current to the VCM 8. As a result, the actuator 5 rotates the arm 6 around the rotation axis 7, thereby moving the head 4 radially relative to the disk 2.

The read head 4R of the head 4 reads the servo data recorded in the servo sector 100 on the disk 2 and outputs the servo signal 40. The controller 10 detects the radial position of the head from position information created by the position detecting unit 11. As described later, the controller 10 controls the actuator 5 on the basis of the position information, thereby enabling position control of the head 4 in units of a minimum offset amount (23 m shown in FIG. 2), the smallest radial servo unit.

On the disk 2, radial servo sectors 100 are arranged at regular intervals as shown in FIG. 1. Servo data is recorded in each of the servo sectors 100. The servo data includes the addresses of the sector and track, and servo burst signals for detecting a position in the track. In the embodiment, the disk 2 is rotated counterclockwise by the spindle motor 3.

On the disk 2, a data recording area eccentrically configured is called a track, a track segmented at regular intervals by the servo sectors 100 is called a servo track 120, and a track formed by writing user data into a data sector 111 is called a data track. An area 110 obtained by combining the servo sector 100 and data sector 111 is simply called a sector. The data sector 111 is a data recording area into which user data has been written by the write head 4w.

FIG. 2 is an enlarged view of the area 20 shown in FIG. 1 to help explain the configuration of the servo sector 100 and track (servo track 120 and data track).

In the servo sector 100, servo data Sct[m] radially divided at specific track intervals have been recorded, with a center line 22 being at the center of the servo track 120. Sct[m] means a sector number corresponding to a sector address. Each of the servo tracks is identified by the track number Stk[n] corresponding to the track address.

On the basis of the track number Stk[n], the controller 10 performs movement control of the head 4 in units of a track. Moreover, the controller 10 positions the head 4 in units of a minimum offset amount of 23 m, the smallest servo unit, using the servo burst signal included in the servo data in the range of one track width 23 of each servo track. In other words, using the servo burst signal, the controller 20 calculates the position error of the head 4 with respect to the track center 22 using the smallest servo unit. The smallest servo unit is also referred to as the resolution RESOL.

In a data write operation, the controller 10 performs control so as to position the head 4 (or write head 4W) in the center of the track 22, thereby writing user data into the data sectors 21A to 21C between servo sectors 100. The data sectors 21A to 21C into which user data has been written are configured to be a part of the concentric data tracks.

(Head Positioning Control)

With the disc drive 1 configured as described above, the embodiment is a servo control system which carries out a head positioning operation with sufficient accuracy even when the track width of the data track is varied on the disk 2 according to the radial position.

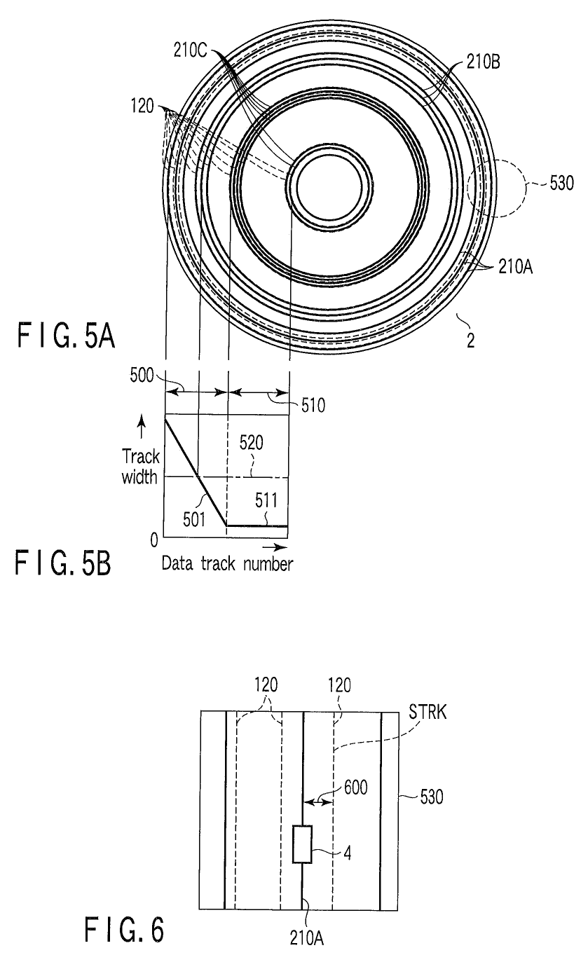

Specifically, as shown in FIGS. 5A and 5B, a data track 210A included in the outer circumferential area on the disk 2 is configured to be wider than the servo track width. The width of a data track 210B included in an intermediate circumferential area on the disk 2 is almost the same as the servo track width. A data track 210C included in the inner circumferential area on the disk 2 is configured to be narrower than the servo track width.

As shown in FIG. 4, the servo tracks 120, which are a concentric track group, are radially arranged at regular intervals. In other words, the servo tracks 120 correspond to a movement locus of the head 4 positioned in the track center line 22 on the basis of the servo data.

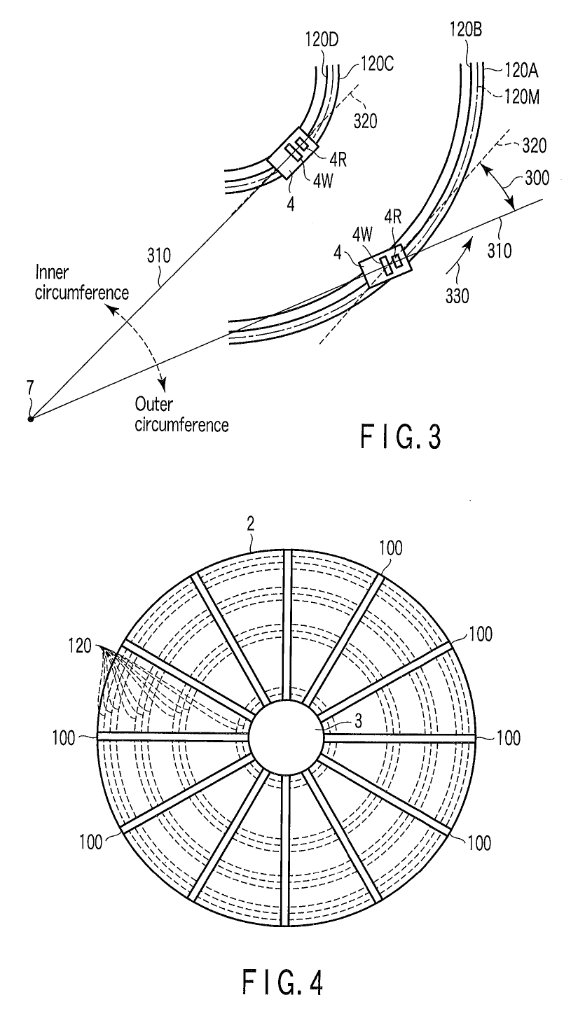

Hereinafter, referring to FIG. 3 and FIG. 5A to FIG. 13, a head positioning control operation of the embodiment will be explained in detail.

FIG. 3 is a diagram to help explain the positional relationship between the head 4 and tracks on the disk 2. Numeral 330 indicates the direction in which the disk 2 rotates.

As shown in FIG. 3, the center of the read/write heads 4R, 4W of the head 4 lies on a straight line 310 from the center of the rotational axis 7 of the arm 6. When the head 4 is positioned on the center line of a track, if the head 4 is on the outer circumference side, an angle 300 develops between a tangent line 320 of the track and the straight line 310. In contrast, if the head 4 is on the inner circumference side, the tangent line 320 of the track and the straight line 310 are on the same line.

In such a positional relationship, when the head 4 is on the inner circumference side, the write head 4W will never interfere with an adjacent data track (servo track center 120C) when being positioned on the data track with a servo track center 120D. In contrast, with the head 4 positioned on the outer circumference side, the write head 4W interferes with an adjacent data track (servo track center 120A) when being positioned on a data track with a servo track center 120B. That is, there is a possibility that the write head 4W will go beyond a center line 120M between adjacent tracks and interfere with the data recorded in the adjacent data track (servo track center 120A).

For such a reason, when disturbance has occurred particularly on the outer circumference side of the disk 2, the chances become higher the head 4 will interfere with adjacent tracks. Therefore, making the track width relatively greater enables head positioning control to be prevented from interfering with the adjacent tracks.

In the disk drive 1, the flexible circuit board 9 is connected to the actuator 5 as shown in FIG. 1. Accordingly, depending on the traverse angle of the arm 6 of the actuator 5, an external force acts in the direction in which the rotation is promoted or prevented. Therefore, depending on the radial position on the disk 2, the external force has an effect on the actuator 5 and therefore it is very likely that the head positioning accuracy will decrease.

FIG. 5A shows the configuration of data tracks 210A to 210C whose track width (the distance between adjacent tracks) is varied by changing the positional offset of the head 4 with respect to the center of the servo track 120. As described above, the servo tracks 120 have a constant track width (the distance between adjacent tracks).

Specifically, as shown in FIG. 5A, the data track 210A included in the outer circumferential area on the disk 2 is configured to be relatively wider than the servo track width. The data track 210B included in the intermediate circumferential area on the disk 2 has almost the same width as the servo track width. Moreover, the data track 210C included in the inner circumferential area on the disk 2 is configured to be relatively narrower than the servo track width.

FIG. 5B shows the relationship between a data track number (track address or cylinder number) on the disk 2 and the data track width. The data track number increases sequentially toward the inner circumference, with the outermost circumference side being 0. The data track 210A included in the outer circumferential area may be referred to as an outer circumferential track, the data track 210B included in the intermediate circumferential area as an intermediate circumferential track, and the data track 210C included in the inner circumferential area as an inner circumferential track.

In FIG. 5B, an interval 500 from the outer circumferential track toward the intermediate circumferential track is a variable zone (501) where data track number 0 corresponds to the largest track width and the track width becomes narrower in linear proportion to the data track number. Numeral 520 indicates the width of a servo track (constant). An interval 510 closer to the inner circumference than the intermediate circumferential track is a fixed zone (511) which is narrower than the width of the servo track 520 and has a constant track width. Moreover, on the disk 2, all of the data tracks may be caused to belong to a track-width-variable zone.

FIG. 6 is an enlarged view of a part 530 shown in FIG. 5A.

Specifically, on the outer circumference side, the head 4 moves from the center 120 of the servo track by a specified offset 600, thereby being positioned in the center 210A of the data track, which causes the head to read data from or write it to a data track with a track width greater than that of the servo track.

(Procedure for Head Positioning Control)

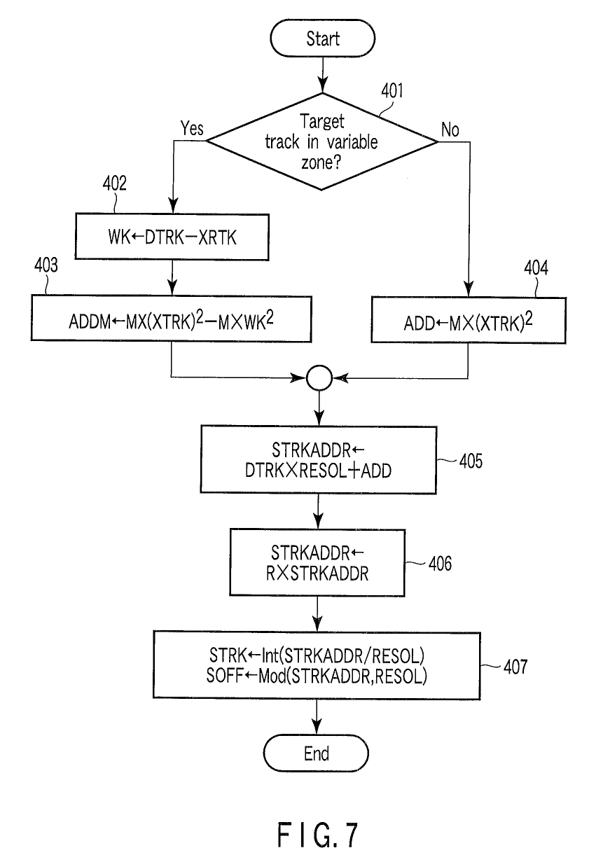

Hereinafter, referring to FIG. 7 to FIG. 11, the procedure for head positioning control will be explained.

FIG. 7 is a flowchart to help explain an algorithm (the procedure for computing the address of a servo track) executed by the controller 10. Suppose the track width of a data track becomes narrower linearly from the outer circumference toward the intermediate circumference (shown in FIG. 5B). It is assumed that the track number of the outermost circumferential data track is 0 and the track number of the innermost circumferential data track is one less than the total number of tracks.

In the flowchart of FIG. 7, DTRK is a target data track number in which the head 4 is to be positioned. XTRK is the number of a boundary track between the variable zone 500 and fixed zone 510 shown in FIG. 5B.

When reading data from or writing it to the disk 2, the controller 10 specifies the track number DTRK of the target data track to be accessed. The controller 10 determines whether the track number DTRK is included in the variable zone 500 (Block 401). If the result of the determination has shown that the track number is included in the variable zone, the controller 10 carries out the processes in Blocks 402 and 403 (YES in Block 401).

Specifically, the controller 10 calculates the difference between the target data track number DTRK and the boundary track number XTRK in the variable zone (Block 402). In addition, the controller 10 substitutes the difference between the result of calculating “constant M X square of XTRK” and the result of calculating “constant M X square of difference WK” into the correction value ADD of the servo track address (Block 403).

In contrast, if the track number DTRK is not included in the variable zone 500, the controller 10 substitutes the result of calculating “constant M×(square of XTRK)” into the correction value ADD of the servo track address (NO in Block 401, Block 404).

Next, using the target data track number DTRK, correction value ADD, and resolution RESOL, the controller 10 calculates servo track position information (Block 405). As shown in FIG. 2, the resolution RESOL is a servo track width of 23 counted using the smallest servo unit corresponding to the minimum offset (23 m), that is, “minimum offset of 23 m×RESOL=servo track width of 23.”

The controller 10 specifies the position of the data track number DTRK in units of the minimum offset (23 m) and does a calculation to correct the position using the correction value ADD. Moreover, the controller 10 multiplies the address, the calculation result STRKADDR by constant R, thereby changing the overall data track width in a specific ratio (Block 406).

Next, the controller 10 obtains the calculation result STRKADDR in such a manner that the servo track number STRK and the servo track offset SOFF are calculated separately (Block 407). The servo track number STRK is a value obtained by truncating the quotient of the servo track address divided by the resolution RESOL to the whole number. The servo track offset is the remainder as a result of the modulo (mod) operation of the servo track address and resolution RESOL.

As described above, the controller 10 makes calculations using the prepared mathematical formulas, thereby determining the correspondence between the target data track number with a variable track width and the position information (address and offset) on the servo track. Instead of make calculations using the mathematical formulas, the controller 10 may store table information that causes the data track number with a variable track width to correspond to the position information on the servo track and determine position information on the servo track for the target data track number, referring to the table information.

In seek control (or head movement control) to position the head 4 on the data track with the target data track number DTRK, the controller 10 specifies a calculated servo track number STRK and moves the head 4 to the center of the servo track. Moreover, the controller 10 fine-adjusts the position of the head 4 in units of a minimum offset corresponding to offset data SOFF, thereby positioning the head 4 in the center of the target data track.

By such head positioning control, the controller 10 specifies the servo track center of the servo track number STRK in the servo track 120 as shown in FIG. 6 and makes a fine adjustment from the servo track center by the offset 600 corresponding to the offset data SOFF, which enables the head 4 to be positioned in the center of the target data track 210.

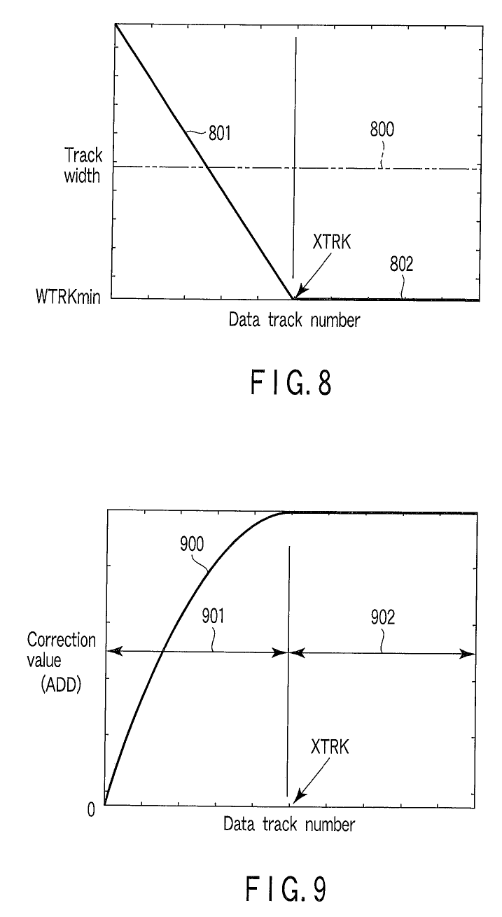

Accordingly, by the head positioning control in the embodiment, the head 4 can be positioned in the center of a data track with the variable track width 801 up to the boundary track number XTRK in the variable zone on the outer circumference side as shown in FIG. 8. In FIG. 8, numeral 800 means the track width (in nanometers) of a servo track 120. Numeral 802 means the track width WTRmin in the fixed zone.

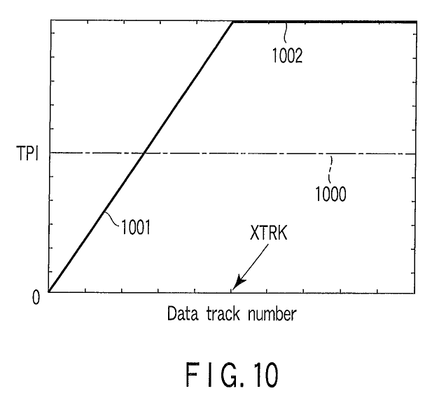

FIG. 9 shows a change in the correction value ADD calculated by the controller 10 in a variable zone 901 and a fixed zone 902. FIG. 10 shows TPI (the number of tracks per inch) 1000 of a servo track, a change 1001 in TPI of a data track in the variable zone, and a change 1002 in TPI of a data track in the fixed zone.

As described above, with the embodiment, a high-accuracy head positioning performance can be secured on the basis of the servo tracks configured at regular intervals on the disk 2, which makes it possible to change the track width of the data tracks according to the radial position (the outer, intermediate, or inner circumference). In other words, the head 4 can be positioned on a data track with a different track width with sufficient accuracy.

Accordingly, it is possible to prevent the write head from interfering with adjacent tracks particularly in a data write operation. Therefore, even when the data track interval has been varied, a sufficiently high-accuracy head positioning operation can be realized using equally spaced servo tracks without decreasing the track density.

### ANOTHER EMBODIMENT

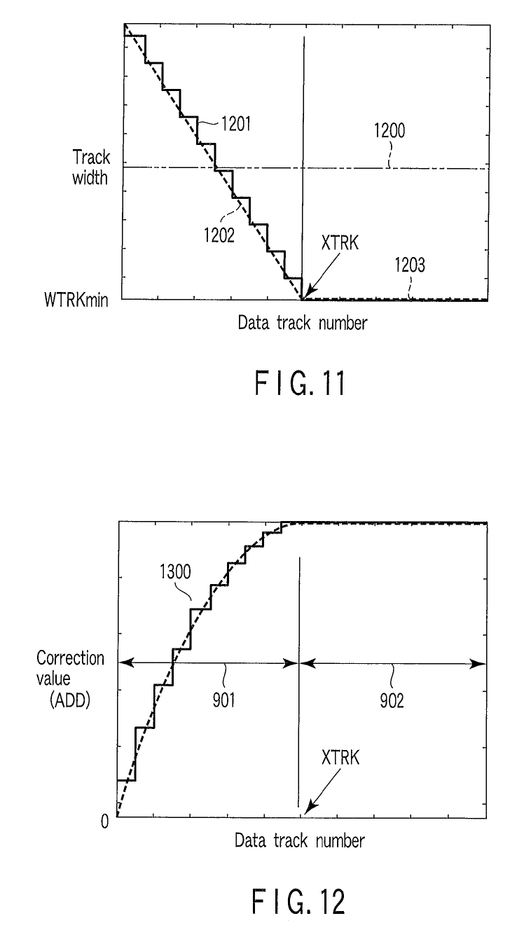

FIGS. 11 and 12 are diagrams to help explain other embodiments of the invention.

FIG. 11 shows a variable track width 1201 in a variable zone corresponding to a data track number and a track width 1203 in a fixed zone. The track width is measured in nanometers. As shown in FIG. 11, the variable track width 1201 in the variable zone may be changed stepwise with respect to a constant servo track width 1200 instead of being subjected to a linear change 1202.

FIG. 12 is a diagram showing a change 1300 in the correction value ADD calculated by the controller 10 in the variable zone 901 and fixed zone 902. As shown in FIG. 12, the correction value ADD may be subjected to a stepwise change 1300 instead of the change 900 of FIG. 9 shown by a dotted line.

In short, the relationship between the data track numbers and the servo track position information may be approximated by not only a linear curve but also a stepwise change.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A disk drive comprising:
a disk configured to have servo tracks including servo sectors in which servo data is recorded; and
a controller configured to detect the position of a target data track on the basis of the position of the servo track and control an actuator to position a head on the data tracks being composed of data recording areas located between servo sectors on the disk by using position information in the servo data, the target data track being included in data tracks whose track widths are varied on the disk.

2. The disk drive of claim 1, wherein the track widths of the data tracks are varied to each of the inner, outer, and intermediate circumferences on a disk.

3. The disk drive of claim 1, wherein the controller determines the position of the target data track using position information on the servo track, position information on the target data track, and a minimum offset.

4. The disk drive of claim 1, wherein each of the data tracks on the disk is configured that the track width of a data track included in the range of the inner circumference is less than the width of the servo track and the track width of a data track included in the range of the outer circumference is greater than the width of the servo track.

5. The disk drive of claim 1, wherein the controller is configured to detect the target data track using information about the function of the positions of the servo tracks configured at regular intervals and the positions of the data tracks.

6. The disk drive of claim 3, wherein the controller is configured to detect the target data track using information about the function of the positions of the servo tracks configured at regular intervals and the positions of the data tracks.

7. The disk drive of claim 1, wherein the controller is configured to distinguish radially relative to the disk the data tracks into a variable zone where the track widths of the data tracks are varied and a fixed zone where the track widths are made substantially constant,
calculate position information on the servo track with respect to the position of the target data track on the basis of the correspondence between the position of the target data track included in the variable zone and the position of the servo track corresponding to the target data track, and
perform positioning control so as to position the head in the range of the target data track on the basis of position information on the servo track.

8. The disk drive of claim 7, wherein the track width of the data track is set in the variable zone so as to change linearly or stepwise.

9. The disk drive of claim 3, wherein the controller is configured to store table information to calculate position information on the servo track corresponding to the position of the target data track on the basis of the correspondence between the position of the target data track and the position of the servo track corresponding to the target data track.

10. A method of positioning a head in a disk drive, comprising:
determining the position of a target data track on the basis of the position of a servo track using position information on the servo track in data tracks which are composed of data recording areas located between servo sectors on a disk and whose track width is varied according to each of the inner, outer, and intermediate circumferences on the disk; and
controlling an actuator to position the head on the target data track.

11. The method of claim 10, wherein the step of determining the position is to determine the position of the target data track using position information on the servo track, position information on the target data track, and a minimum offset.

12. The method of to claim 10, wherein the step of determining the position is to determine the target data track using information about the function of the positions of the servo tracks configured at regular intervals and the positions of the data tracks.

13. The method of claim 10, further comprising:
distinguishing radially relative to the disk the data tracks into a variable zone where the track width of the data tracks is varied and a fixed zone where the track width is made substantially constant,
wherein the step of determining the position is to calculate position information on the servo track with respect to the position of the target data track on the basis of the correspondence between the position of the target data track included in the variable zone and the position of the servo track corresponding to the target data track, and
the step of positioning the head is to control the actuator to perform positioning control of the head on the basis of position information on the servo track so as to position the head on the target data track.
